(19) United States
(12) Patent Application Publication
(10) Pub. No.: US 2020/0275809 A1
(43) Pub. Date: Sep. 3, 2020

(54) ABSORBENT STACK OF SHEETS HAVING COMPRESSED BINDING

(71) Applicant: Kimberly-Clark Worldwide, Inc., Neenah, WI (US)

(72) Inventors: Julie Ann Paveletzke, Appleton, WI (US); Christopher Peter Olson, Neenah, WI (US)

(21) Appl. No.: 16/759,578

(22) PCT Filed: Oct. 31, 2017
(86) PCT No.: PCT/US17/59215

§ 371 Date: Apr. 27, 2020

(51) Int. Cl. A47K 10/16; B31F 5/02; B32B 29/00; D21H 27/30; D21H 27/00

(52) U.S. Cl. CPC A47K 10/16; B31F 5/02; B32B 29/00; B32B 2307/50; D21H 27/002; B32B 2250/26; B31F 2201/07; D21H 27/30

(57) ABSTRACT

Disclosed are stacks of absorbent sheets, such as paper towels, toilet tissue, napkins, facial tissue, and the like. The stacks generally comprise a plurality of absorbent sheets bound by compressing the sheets to form a binding element. The binding element is generally free from adhesives or mechanical fasteners, and acts to bind the sheets to one another and form the 5 stack. The binding element may be disposed along only a portion of the stack or may extend continuously across a first dimension of the stack Binding the stack in this manner generally results in individual sheets arranged in facing arrangement with one another without an adhesive disposed between them and as such the entire sheet may be used once it is dispensed from the stack.

### BACKGROUND OF THE INVENTION

Consumers want easy, convenient and quick access to absorbent sheet products, such as paper towels, toilet tissue, napkins, facial tissue, and the like, for use in their home or work areas. Particularly, consumers want the products available where spills or messes occur, which are often in areas of the home where such products are traditionally kept, such as the kitchen or bathroom. When spills or messes occur in these areas consumers want quick and convenient access to absorbent sheets to clean up messes quickly to avoid damage to surfaces throughout the home. Therefore, there is a need for absorbent sheets, and particularly stacks of absorbent sheets, that may be easily located throughout the home and provide a convenient dispensing format to ensure easy, convenient and quick access to sheets where and when consumers need them.

Not only do consumers desire sheet formats that are easy and convenient to use, they also want formats that are aesthetically pleasing and compliment their home decor. Often to provide the ease and convenience consumers desire, the sheet products are designed to be left in plain view in the home rather than stored away in cabinets. As such the products must be aesthetically pleasing and function as a home accessory.

Therefore, there is a need in the art for an absorbent sheet product that provides consumers with a convenient and easily accessible dispensing when and where the consumer needs such products. Furthermore, there is a need for a dispensing format that functions as a home accessory and compliments the consumers home decor.

### SUMMARY OF THE INVENTION

The present invention addresses the consumers need for a convenient and easily accessible dispenser for absorbent sheets. The present stack is compact, sleek and the use of compression, rather than an adhesive or a mechanical fastener, to form the binding allows the entire sheet to be used. Moreover, the stack may be mounted in a number of different places, providing the consumer with easy access to absorbent sheets throughout the home. For example, the stack may be laid flat on a horizontal surface, such as a countertop or table, or may be mounted to a vertical surface, such as a wall or cupboard using conventional and readily available mounting hardware such as adhesives or mechanical fasteners.

Accordingly, in one embodiment the present invention provides a plurality of absorbent sheets stacked in facing arrangement with one another to form a stack having a bottom and a top edge, the stack having a compressed portion adjacent to the top edge, the compressed portion having a thickness that is less than the thickness of the bottom edge of the stack. Generally the compressed portion does not comprise an adhesive or mechanical fastener to bind the sheets to one another and form the stack. In this manner the individual sheets in the stack are generally arranged in facing arrangement with one another without an adhesive disposed between them and as such the entire sheet may be used once it is dispensed from the stack. Further, the compressed area is generally free from mechanical fasteners such as rivets, staples, pins, screws, wire, and the like, and as such when a sheet is dispensed from the stack it is undamaged.

In other embodiments the sheets forming the stack may be substantially free from perforations or lines of weakness such that in-use the sheet removed from the stack has approximately the same dimensions as the stack itself. Forming a stack where the sheets are bound to one another by compression only and may be separated from one another by a simple peeling action provides a stack that is both easily manufactured and simple to dispense.

In other embodiments the present invention provides a stack of absorbent sheets comprising a plurality of absorbent sheets having a machine direction and a cross-machine direction stacked in facing arrangement to form a stack of absorbent sheets, the stack having a top edge and a bottom edge; a binding element for binding the sheets together to form a stack disposed adjacent to the top edge of the stack, the binding element consisting essentially of a compressed portion of the plurality of absorbent sheets and having a first thickness, wherein the first thickness is less than the thickness of the stack at the bottom edge.

In another embodiment the present invention provides a plurality of absorbent sheets having a machine direction and a cross-machine direction stacked in facing arrangement without an adhesive disposed there between to form a stack of absorbent sheets, the stack having a top edge and a bottom edge; the stack having a compressed region and an uncompressed region, wherein the compressed region forms a continuous binding element having a thickness (T₁) that is less than the thickness of the uncompressed region (T₃).

In yet other embodiments the present invention provides a method of manufacturing a stack of absorbent sheets bound without the use of adhesives or mechanical fasteners comprising the steps of providing a plurality of absorbent sheets; stacking the plurality of absorbent sheets in facing arrangement with one another such that the facings of adjacent sheets in the stack are in direct contact with one another; passing a portion of the stack through a nip loaded with a force of at least about 5,000 pounds per square inch (psi, where 1 psi equals 0.069 bars), such as from about 5,000 to about 40,000 psi and more preferably from about 10,000 to about 30,000 psi, such as from about 15,000 to about 25,000 psi, to compress a portion of the stack and form a binding element and an adjacent uncompressed region, wherein the binding element has a thickness (T₁) that is less than the thickness of the uncompressed region (T₃).

### BRIEF DESCRIPTION OF DRAWINGS

FIG. 1 is a perspective view of stack of absorbent sheets according to one embodiment of the present invention;

FIG. 2 is a cross-sectional view of the stack of FIG. 1 through line 2-2;

FIG. 3 is a cross-sectional view of the stack of FIG. 1 through line 3-3;

FIG. 4 is a perspective view of a stack of absorbent sheets according to another embodiment of the present invention;

FIG. 5 is a cross-sectional view of the stack of FIG. 4 through line 5-5;

FIG. 6 is a cross-sectional view of the stack of FIG. 4 through line 6-6;

FIG. 7 is a perspective view of a stack of absorbent sheets according to yet another embodiment of the present invention;

FIG. 8 is a cross-sectional view of the stack of FIG. 7 through line 8-8;

FIG. 9 is a cross-sectional view of the stack of FIG. 7 through line 9-9;

FIG. 10 is a perspective view of a stack of absorbent sheets according to another embodiment of the present invention;

FIG. 11 is a perspective view of a stack of absorbent sheets according to yet another embodiment of the present invention; and

FIG. 12 is a perspective view of a stack of absorbent sheets according to still another embodiment of the present invention.

### DETAILED DESCRIPTION OF PARTICULAR EMBODIMENTS

The invention relates to a stack of absorbent sheets, such as paper towels, toilet tissue, napkins, facial tissue, and the like. The stack generally comprises a plurality of absorbent sheets bound by compressing the plurality of sheets adjacent to a first edge, such as the top edge. Generally the compressed portion does not comprise an adhesive or mechanical fastener that binds the sheets to one another and form the stack. In this manner the individual sheets in the stack are generally arranged in facing arrangement with one another without an adhesive disposed between them and as such the entire sheet may be used once it is dispensed from the stack. Further, the compressed area is generally free from mechanical fasteners such as rivets, staples, pins, screws, wire, and the like, and as such when a sheet is dispensed from the stack it is undamaged.

In other aspects the invention provides a stack of absorbent sheets where the sheet has similar dimensions to the stack of sheets after being dispensed and where the entire sheet may be used by the consumer. For example, in addition to providing a stack that is free from adhesive and mechanical fasteners, the present invention provides a stack in which individual sheets are free from perforations or lines of weakness. Rather than rely upon perforations or lines of weakness to create a means of separating individual sheets from the stack, the sheets may be removed from the stack in their entirety by simply peeling one sheet away from the next. In this manner the dispensed sheet has dimensions, such as a length and a width, that are substantially similar to the length and the width of the stack.

While in certain embodiments it may not be necessary to provide individual sheets with perforations or lines of weakness to allow a user to remove a sheet from the stack, in other embodiments it may be desirable to provide the sheets with perforations or lines of weakness so that a user may only remove a portion of the sheet from the stack. For example, in one embodiment, the stack of absorbent sheets may comprise a binding element having a compressed portion and a first line of stitches wherein individual sheets comprise a line of perforations wherein the perforations bisect the sheet in either the machine or cross-machine direction. In such embodiments it may be preferable to place the line of perforations away from the binding element and in a position such that the sheet is divided in two substantially equal halves by the line of perforations.

The stack is generally formed from a plurality of absorbent sheets stacked one on top of the other in face-to-face relation with a binding element joining a portion of the sheets together. The binding element does not comprise an adhesive or a mechanical fastener such that the inwardly oriented face of each sheet in the stack directly contacts the outwardly oriented face of the next adjacent sheet in the stack. The sheets are joined to one another such that the attachment strength is at least about 15 grams, more preferably at least about 25 g, and still more preferably at least about 40 g, such as from about 15 to about 100 g. In this manner the stacks of absorbent sheets have attachment strengths comparable or greater than stacks joined using adhesive or mechanical fasteners. As used herein, the term “attachment strength” refers to the peak force, typically having units of grams (g), necessary to separate an absorbent sheet from the stack. Attachment strength is measured according to Standard Test Method (STM) 00317, which measures the Kinetic peak force required to separate a sheet from the stack.

The absorbent sheets are preferably fibrous sheet material. In a particularly preferred embodiment the sheets comprise a cellulosic fibrous material, such as wood pulp, cotton linters, or the like. However in other embodiments the sheets may comprise synthetic fibers, such as polyolefin or polyester fibers. In still other embodiments the sheets may comprise a mixture of cellulosic and synthetic fibers. In certain instances the absorbent sheets may comprise wet laid tissue products such as bath tissue, facial tissue, paper towels, napkins, or the like. In other instances the absorbent sheets may comprise nonwoven materials formed from synthetic fibers or blends of synthetic and cellulosic fibers with similar properties to those of wet laid tissue products formed from cellulosic fibers. In certain embodiments the absorbent sheets may comprise nonwoven airlaid sheets comprising synthetic fibers, binders, wet strength agents, and the like.

Further, while in certain instances, such as those illustrated in the present figures, the stack may be formed from absorbent sheets comprising a single ply, it is to be understood that the present disclosure is not so limited and the absorbent sheet may comprise two or more plies, such as two, three or four plies. The plies may consist substantially of the same fibrous material, or they may be different. For example, in one embodiment all of the plies comprise wood pulp fibers. In another embodiment one ply comprises synthetic fibers and another ply comprises wood pulp fibers.

The absorbent sheet material may be folded or unfolded. In certain embodiments the individual sheets within the stack may be folded to form a folded sheet having multi-layers. Upon removal of an individual sheet from the stack it may be unfolded to yield a single absorbent sheet having a surface area greater than the surface area of the stack. Accordingly, individual absorbent sheets within a stack, in an embodiment, may be in a folded configuration such as half-folds or quarter-folds of the sheets. For example, a sheet having a half-fold configuration may have four different edges, a first end and a second end, opposite the first end. A binding element is disposed along the first end to enable the sheets to be removed individually from the stack. Other folding configurations may also be useful herein, for example, Z-folds, or C-folds.

Further, it should be understood that the sheets and the resulting stack may take any number of different shapes and that while it may be desirable for two or more edges of sheets to be aligned with one another, the invention is not so limited. Additionally the size of individual sheets and the number of sheets in the stack corresponds to the number of usable units desired in the finished tissue product.

In particularly preferred embodiments the stacks comprise absorbent sheet material having a basis weight greater than about 10 grams per square meter (measured using TAPPI test method T-220) such as from about 10 to about 100 gsm and more preferably from about 15 to about 70 gsm. In other embodiments the sheets may have a caliper (measured in accordance with TAPPI test method T402 using an EMVECO 200-A Microgage automated micrometer (EMVECO, Inc., Newberg, Oreg.)) greater than about 200 μm, such as from about 200 to about 2000 μm. Further, the absorbent sheet material may have a specific absorbency greater than about 2.0 g/g, such as from about 2.0 to about 15.0 g/g and more preferably from about 5.0 to about 10.0 g/g. As used herein, the term “specific absorbency” generally refers to the amount of water absorbed by a paper product (single ply or multi-ply) or a sheet, expressed as grams of water absorbed per gram of fiber (dry weight) and is measured as described in U.S. Pat. No. 8,753,751, the contents of which are incorporated by reference in a manner consistent with the present disclosure.

In other embodiments the absorbent sheets have a dry geometric mean tensile strength (measured in accordance with TAPPI test method T-494 om-01) greater than about 500 g/3″, and more preferably greater than about 750 g/3″ and still more preferably greater than about 1,000 g/3″, such as from about 500 to about 3,500 g/3″ and more preferably from about 1,000 to about 2,500 g/3″. In this manner the absorbent sheets have sufficient tensile strength to withstand the force necessary to detach individual sheets from the stack.

In certain preferred embodiments the absorbent sheets comprise a wet laid tissue product that has been manufactured by through-air drying, such as tissue products disclosed in U.S. Pat. No. 4,529,480. In other embodiments the absorbent sheets comprise a wet laid tissue product that has been manufactured by through-air drying and without creping, such as tissue products disclosed in U.S. Pat. No. 8,753,751. The through-air dried absorbent sheets may be embossed and may comprise, one or more plies, such as one, two or three plies.

In other embodiments the absorbent sheets may comprise wet laid tissue products having at least one surface that has been treated with a binder, such as tissue products disclosed in U.S. Pat. No. 7,462,258. Suitable binders include, without limitation, latex binder materials such as acrylates, vinyl acetates, vinyl chlorides and methacrylates, and the like. The binders may be created or blended with any suitable cross-linker, such as N-Methylolacrylamide (NMA), or may be free of cross-linkers. Particular examples of latex binder materials that can be used in the present invention include AIRFLEX® EN1165 available from Air Products Inc. or ELITE® PE BINDER available from National Starch. Other suitable binders include, without limitation, carboxylated ethylene vinyl acetate terpolymer; acrylics; polyvinyl chloride; styrene-butadiene; polyurethanes; silicone materials, such as curable silicone resins, organoreactive polysiloxanes and other derivatives of polydimethylsiloxane; fluoropolymers, such as tetrafluoroethylene; hydrophobic coacervates or complexes of anionic and cationic polymers, such as complexes of polyvinylamines and polycarboxylic acids; polyolefins and emulsions or compounds thereof; and many other film-forming compounds known in the art, as well as modified versions of the foregoing materials. The binder materials can be substantially latex-free or substantially natural latex-free in some embodiments.

In those embodiments where the absorbent sheets comprise a binder it may be preferable that the binder is discontinuous in the sense that it is not a solid film in order to allow liquid or moisture to penetrate into the sheet. It can be present in the form of a regularly or irregularly spaced-apart pattern of uniform or non-uniform deposits, such as provided by printing or a thinly-applied spray, for example. In one particular embodiment, the deposits can have a diameter of about 0.02 inch (0.51 mm) and can be present in the pattern so that deposits extend in both the machine direction and the cross-machine direction.

For each of the two outer surfaces of the product, the percent surface area coverage of the binder, as projected in a plan view of the surface, can be from about 10 to about 70 percent, more specifically from about 10 to about 60 percent, more specifically from about 15 to about 60 percent, more specifically from about 20 to about 60 percent, and still more specifically from about 25 to about 50 percent. The surface area coverage of each outer surface can be the same or different. As used herein, “surface area coverage” refers to the percent of the total area covered by the binder when measuring at least 6 square inches (38.7 square centimeters) of the web.

Regardless of the percent surface area coverage of the binder, the binder is not preferentially disposed on any single surface region of the sheet. Rather, the binder is generally disposed throughout the surface area of the sheet such that when the sheets are bound to one another the portion of the sheet in the compressed region and the portion of the sheet in the uncompressed region both comprise binder and more preferably comprise substantially the same amount of binder. For example, the binder may be disposed on the sheet surface in a continuous or semi-continuous pattern such that the percent surface area coverage of the binder, as projected in a plan view of the surface, can be from about 10 to about 70 percent, in both the sheet surface area that is compressed and uncompressed.

The total add-on amount of the binder, based on the weight of the product, can be about 2 weight percent or more, more specifically from about 2 to about 20 dry weight percent, more specifically from about 4 to about 9 dry weight percent, still more specifically from about 5 to about 8 dry weight percent. The add-on amount can be affected by the desired surface area coverage and the penetration depth of the deposits. The add-on amount applied to each outer surface of the product can be the same or different.

Regardless of the particular construction of the absorbent sheet materials, in certain preferred embodiments the stack is formed without the addition of adhesives. As such, in a preferred embodiment, each sheet in the stack has a front and back surface having a substantially similar composition from its top edge to its bottom edge and from its first side edge to its second side edge. In this manner there is no material selectively disposed on only a portion of the sheet surface such that when two facing surfaces of sheets are stacked and arranged they are attached to one another. Rather than rely upon adhesives to bind the sheets, the intrinsic properties of the absorbent sheet are combined with pressure to form the compressed region, which is stitched to form the binding element. For example, in one embodiment a plurality of absorbent sheets comprising a wet laid cellulosic tissue product having a specific absorbency greater than about 2.0 g/g and a basis weight from about 10 to about 60 gsm are cut to size, stacked in facing arrangement and bound together by applying pressure to a portion of the stacked sheets to form a binding element and attach the sheets to one another and then the compressed stack is sewn to provide a first line of stitches. The binding element, which is preferably free from adhesives, has a thickness less than the unbound portion of the stack, but is otherwise substantially similar in composition. These and other embodiments will now be discussed in more detail with reference to the figures.

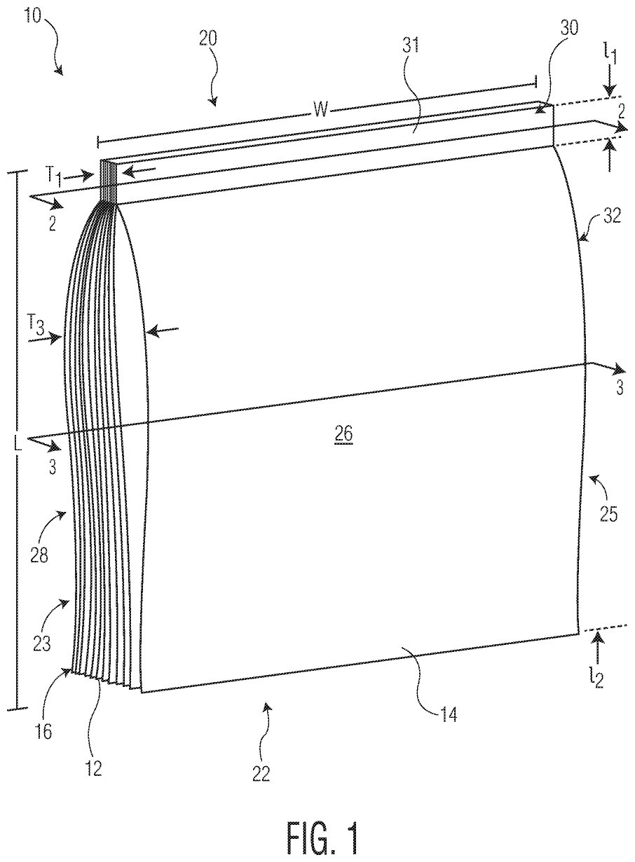

Generally, in one embodiment of the present invention, such as that illustrated in FIG. 1, the stack 10 comprises a plurality of individual absorbent sheets 12 with a top most sheet 14 and a back sheet 16 forming the front 26 and back 28 of the stack respectively. The stack 14 has a top edge 20, a bottom edge 22 and a pair of opposed side edges 23, 25. The distance between the top and bottom edges 20, 22 generally defines the stack length (L) and the distance between the pair of opposed side edges 23, 25 defines a stack width (W). The stack further comprises a compressed portion 30 forming a binding element 31, which is disposed adjacent to the top edge 20. The binding element 31 has a width that is substantially equal to the width (W) of the stack and a length (l₁) that is a fraction of the stack length (L). In addition to the compressed portion 30, the stack 10 comprises an uncompressed portion 32, a width that is substantially equal to the width (W) of the stack and length (l₂) that is a fraction of the stack length (L).

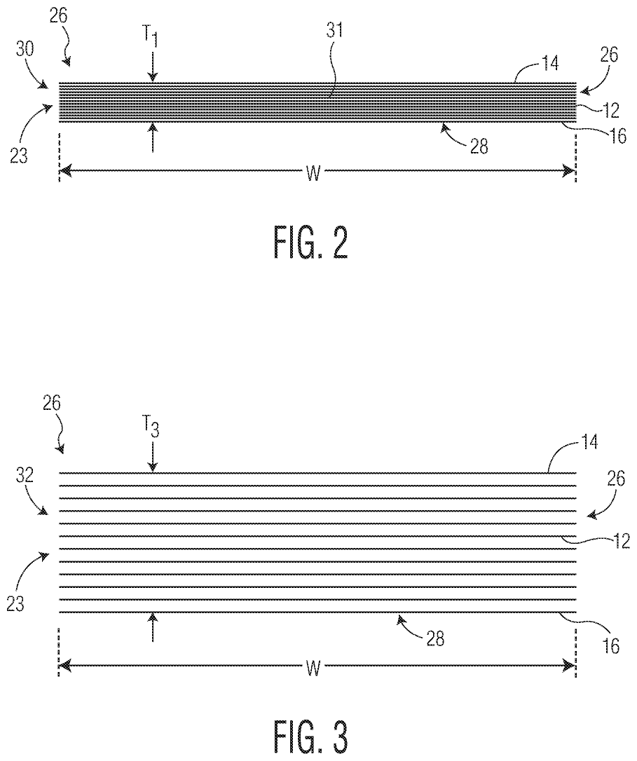

The individual sheets 12 are bound together by compression to form a compressed portion 30 having a thickness (T₁) that is generally less than the thickness (T₃) of the uncompressed portion 32, as shown in FIGS. 2 and 3. In this manner the stack comprises a compressed portion that binds the sheets together and forms a binding element 31. The binding element 31 binds the sheets 12 together and maintains the integrity of the stack 10. In certain embodiments, the binding element is substantially free from adhesives and mechanical fasteners and is sufficiently strong to bind and retain the sheets. As such, in a preferred embodiment, individual sheets within the stack are stacked in facing arrangement without an adhesive disposed there between. Further, it is generally preferred that no adhesive is applied to any edge of the stack, such as the top edge or one or more side edges. In still other embodiments, the attachments of sheets created by compression in the compressed portion is sufficiently strong so as not to require any other form of mechanical attachment, such as rivets, staples, pins, screws, wire, and the like.

With continued reference to FIG. 1, the stack 10 generally has a compressed portion 30 and an uncompressed portion 32, where the compressed portion 30 forms the binding element 31 having a first thickness (T₁) that is less than the thickness of the unbound portion, also referred to as the uncompressed portion or the second thickness, (T₃) (shown in detail in FIGS. 2 and 3). In certain instances the first thickness (T₁) may be about 50 percent of the second thickness (T₃), such as from about 5.0 to about 50 percent of the second thickness (T₃) and more preferably from about 7.0 to about 20 percent of the second thickness (T₃), and still more preferably from about 10 to about 15 percent of the second thickness (T₃). For example, in certain embodiments the stack may comprise about 30 absorbent sheets stacked in facing arrangement with one another and the first thickness (T₁) may be from about 1.0 to about 3.0 mm, such as from about 1.50 to about 2.00 mm and more preferably from about 1.70 to about 1.90 mm and the second thickness (T₃) may be from about 10.0 to about 30.0 mm, such as from about 12.0 to about 25.0 mm and more preferably from about 14.0 to about 20.0 mm.

The thickness of the stack, whether in the compressed or uncompressed regions, may be measured using a conventional digital caliper, such as a Mitutoyo Absolute Digimatic Caliper Series 500 (commercially available from Mitutoyo America Corporation, Aurora, Ill.). The thickness of the stack may be measured according to the caliper manufacturer's instructions taking care to measure the thickness of the uncompressed region at least 20 mm away from any edge of the stack and at least 10 cm away from the compressed region. Generally the thickness is the average of five measurements and each measurement is taken at regular intervals across the entire width of the stack, preferably in a line that is at a right angle to the machine-direction of the absorbent sheets in the stack.

It is generally preferred that at least one edge of the stack is unbound and more preferably at least two edges and still more preferably at least three edges are unbound. In this manner the user may readily grasp an unbound edge and dispense the upper most sheet from the stack. For example, with reference to FIG. 1, the bottom edge 22 and portion of the opposed side edges 23, 25 are unbound and have a relatively uniform thickness (T₃) that is less than the thickness (T₁) of the bound portion 30.

As illustrated in FIGS. 1 and 2 the compressed portion 30 extends across the width (W) of the stack 10 and has a relatively uniform thickness (T₁) across its width. Further, the compressed portion 30 is continuous and oriented substantially parallel to the first and second ends 20, 22. In this manner the width of the binding element 31 is substantially equal to the width (W) of the stack 10. While the binding element is illustrated as being oriented longitudinally and parallel to the top and bottom edges of the stack, the element itself may comprise any desired geometry and may be either continuous or discontinuous.

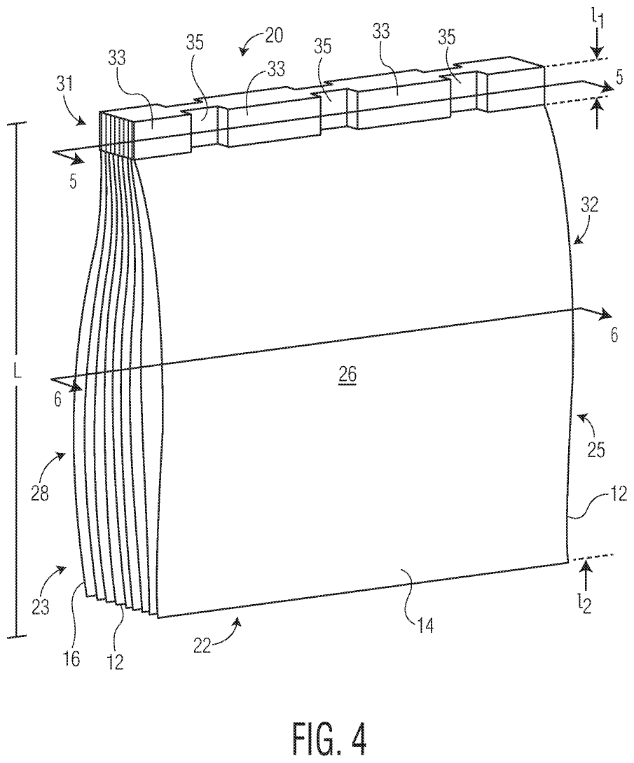

As used herein “continuous,” when referring to a binding element, generally means that along the length dimension of the binding element its thickness is less than the thickness of the uncompressed portion of the stack. A binding element or compressed portion may be continuous despite slight variations in thickness so long as the thickness of the element does not equal or exceed the thickness of the uncompressed portion of the stack along its length. For example, with reference to FIGS. 4-6 the binding element 31 may be referred to as being continuous as the thickness along its length dimension is less than the thickness (T₃) of the unbound portion 32 throughout the width (W) dimension of the stack 10.

In other embodiments the binding element may be discontinuous. As used herein the term “discontinuous,” when referring to a binding element, generally means that along the length dimension of the binding element its thickness equals or exceeds the thickness of the uncompressed portion of the stack. In certain embodiments a discontinuous binding element may comprise a plurality of discrete compressed areas having a first thickness separated from one another by uncompressed areas having a thickness which is generally equally to the thickness of the uncompressed region of the stack.

With continued reference to FIG. 1, the compressed portion 30 forming the binding element 31 is disposed immediately adjacent to the top edge 20 of the stack 10 and its length (l₁) is only a small fraction, such as from 5 to about 15 percent, and more preferably from about 7 to about 12 percent, of the length (l₂) of the uncompressed portion 32. The dimensions and placement of the compressed portion and the resulting binding element however, may vary.

With reference now to FIG. 4, the stack 10 comprises a binding element 31 disposed along the top edge 20 and joining a plurality of sheets 12 together. The binding element 31 may be referred to as being continuous as its thickness is less than the thickness (T₃) of the unbound portion 32 through the width (W) dimension of the stack 10. The binding element 31 comprises discrete first and second compressed portions 33, 35 which are generally arranged in an alternative fashion and are similarly shaped, but have different thicknesses (T₁ and T₂). The binding element 31 binds the sheets 12 together and maintains the integrity of the stack 10. In certain embodiments, the binding element is substantially free from adhesives and mechanical fasteners and is sufficiently strong to bind and retain the sheets. As such, in a preferred embodiment, individual sheets within the stack are stacked in facing arrangement without an adhesive disposed there between. Further, it is generally preferred that no adhesive is applied to any edge of the stack, such as the top edge or one or more side edges.

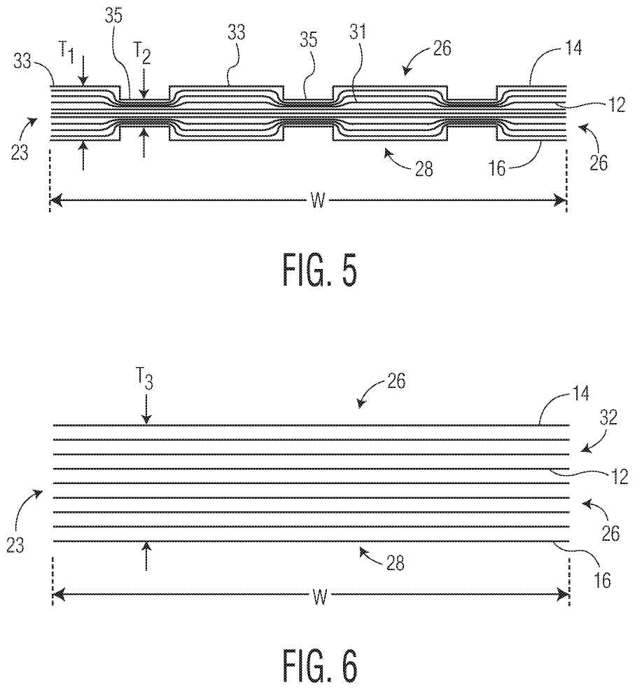

With continued reference to FIG. 4, the first compressed portions 33 are discrete and generally have a rectilinear shape and first thickness (T₁). The second compressed portions 35, which are separated from one another by the first compressed portions 33, are similarly shaped and sized to the first compressed portions 33, but have a lesser thickness (T₂) (shown in detail in FIGS. 5 and 6). Together the first and second compressed portions 33, 35 form the binding element 31, which has a maximum thickness (T₁) that is less than the thickness of the uncompressed portion 32 of the stack 10, which has a third thickness (T₃). In certain instances thickness (T₂) of the second compressed portions 35 may be from about 30 to about 90 percent, such as from about 40 to about 60 percent of the thickness (T₁) of the first compressed areas 33, which may in-turn be from about 30 to about 90 percent, such as about 40 to about 60 percent of the thickness (T₃) of the uncompressed area 32.

Again, the shape and orientation of the binding element may vary and may comprise continuous or discrete compressed areas of varying shape and size. For example, the binding element may be disposed some distance away from the top edge of the stack and be discontinuous consisting of a plurality of discrete circular compressed areas. In other instances the binding element may be arranged perpendicular to the top edge of the stack and spaced away from one of the side edges a distance and be continuous consisting of a plurality of discrete rectilinear compressed areas.

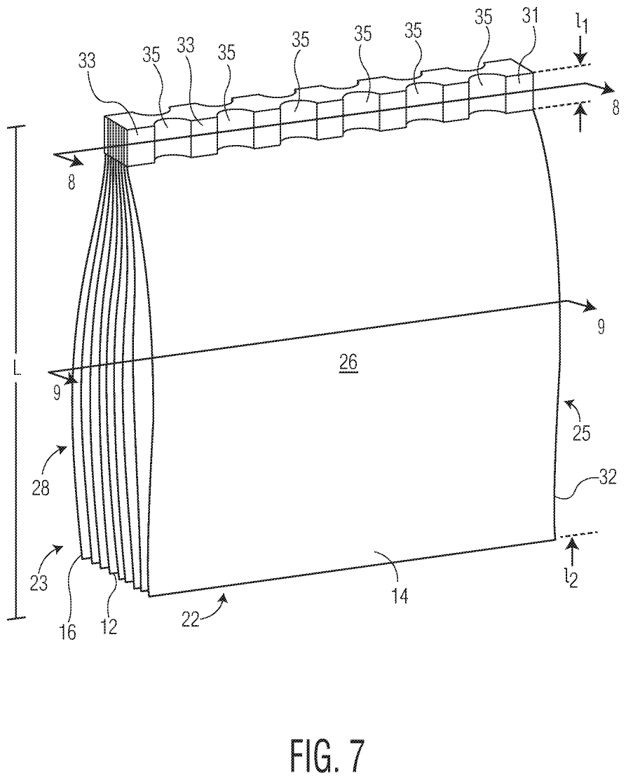

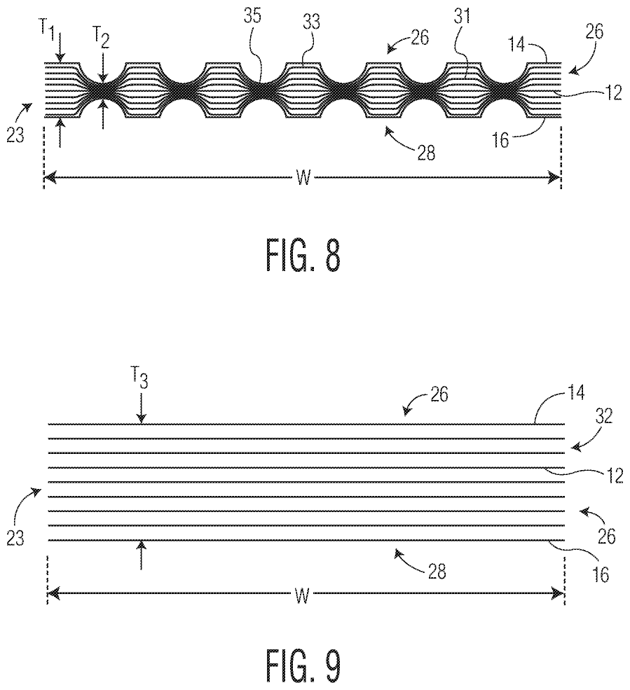

With reference now to FIGS. 7-9 another embodiment of a stack 10 of absorbent sheets 14 is illustrated. The stack 10 comprises a binding element 31 disposed along the top edge 20 of the stack 10. The binding element 31 joins a plurality of sheets 12 together to form the stack 10. The binding element 31 is continuous in the width dimension (W), as its thickness is less than the thickness (T₃) of the uncompressed portion 32 through the width (W) of the stack 10. The binding element 31 comprises discrete first compressed portions 35 that are separated from another by discrete second compressed portions 33, which are less compressed than the first compressed portions. The binding element is substantially free from adhesives and mechanical fasteners and is sufficiently strong to bind and retain the sheets. As such, in a preferred embodiment, individual sheets within the stack are stacked in facing arrangement without an adhesive disposed there between. Further, it is generally preferred that no adhesive is applied to any edge of the stack, such as the top edge or one or more side edges.

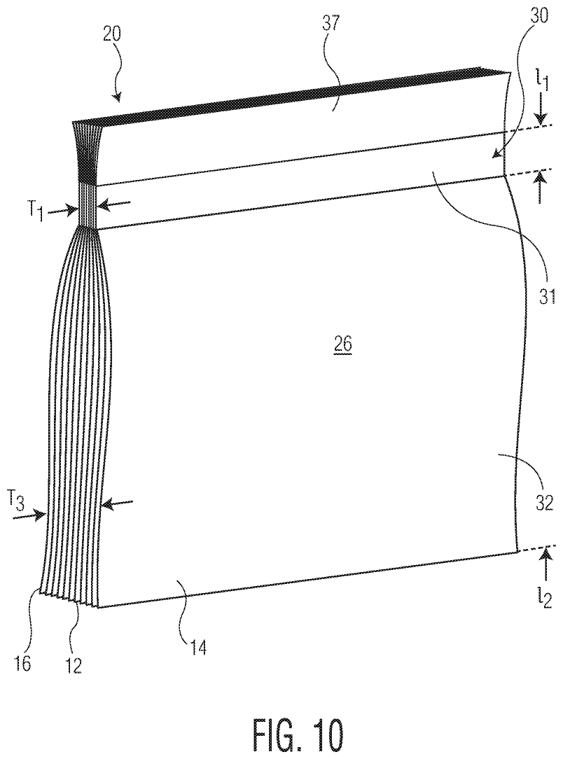

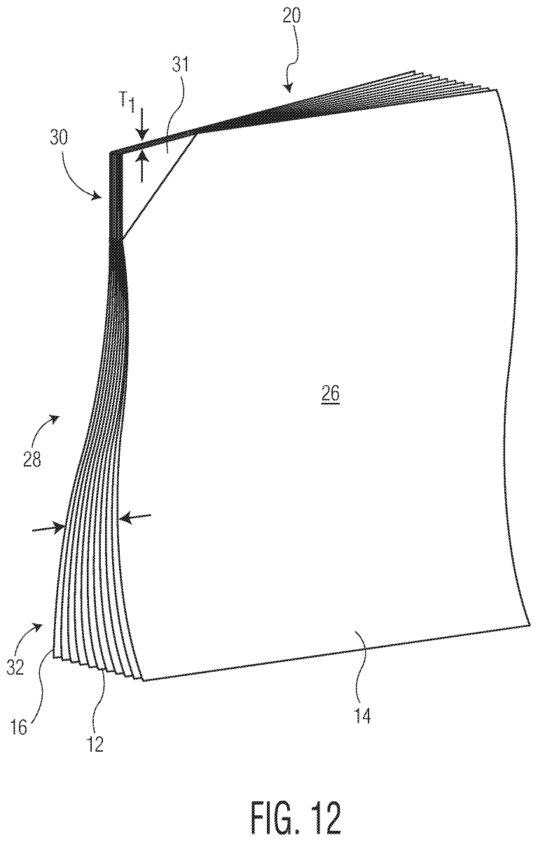

The dimensions and placement of the compressed portion and the resulting binding element however may vary. Further, the binding element may be continuous or discontinuous. For example, in certain embodiments, such as the embodiment illustrated in FIG. 1, the binding element 31 may be continuous and form the entire edge of the stack, such as the top edge. In other embodiments the binding element may be formed from a continuous compressed portion having a substantially uniform thickness across the width dimension the stack and be disposed a distance away from the top edge of the stack so as to provide an unbound portion both above and below, such as the embodiment illustrated in FIG. 10. In other embodiments, such as that illustrated in FIG. 12, the binding element 31 may be formed from a compressed portion 30 having a thickness (T₁) which forms a portion of two edges 20, 28 of the stack 10. In still other embodiments the binding element may be continuous, but may comprise discrete, discontinuous compressed portions so as to provide the binding element with two or more thicknesses. In still other embodiments the binding element may be discontinuous.

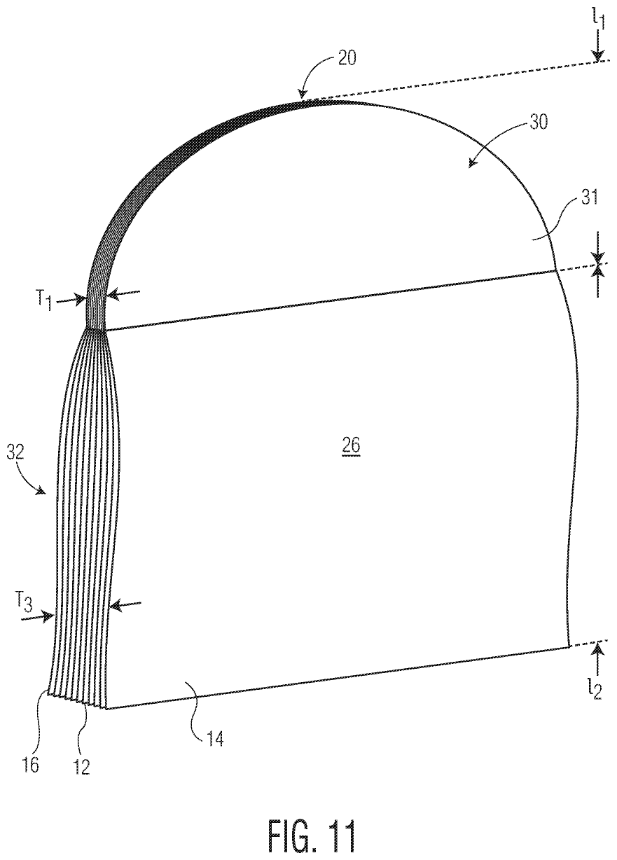

Further, while in certain embodiments the shape of the binding element may be a straight line having a width (W) and a length (l₁), the invention is not so limited and the shape of the binding element may be varied to accommodate sheets having different shapes and to form stacks having different dispensing properties. For example, the embodiment illustrated in FIG. 11, the sheet 12 is not rectilinear and the binding element 31, formed from a compressed portion 30 having a thickness (T₁), is shaped similar to the upper edge 20 of the sheet 12. In this manner the binding element 31 has a curvilinear shape and forms the upper edge 20 of the stack. In other embodiments, such as that illustrated in FIG. 12, the binding element 31, formed from a compressed portion 30 having a thickness (T₁), is disposed in a corner of the stack 10 so as to form a portion of the top and side edge 20, 28 of the stack 10.

While it is generally preferred that sheets within the stack are bound to one another without the use of adhesive disposed between the sheets or the use of mechanical fasteners, in certain instances it may be preferable to provide the stack with a back sheet that is attached to the bottom most sheet in the stack by an adhesive or a mechanical fastener. The backing sheet may be provided, but not folded over the sheets so as to provide rigidity to the stack. The backing sheet may extend the entire length of the stack or may extend along only a portion of its length, such as from 10 to 50 percent of the length of the stack.

The backing sheet may be formed from paper, cardboard, paperboard, plastic, metal, or combinations thereof. In particularly preferred embodiments the dispensing panel is formed from paper, cardboard, or paperboard. More preferably, the dispensing panel is formed from paperboard, optionally coated with one or more layers of plastic. The backing sheet is generally formed from a semi-rigid sheet having a bending stiffness greater than the bending stiffness of one of the absorbent sheets in the stack. For example, the backing sheet may having a bending stiffness from about 100 to about 400 Taber Stiffness Units and more preferably from about 200 to about 300 Taber Stiffness Units. A Taber Stiffness Unit is the equivalent of one gram centimeter. The method used herein for measuring Taber Stiffness is TAPPI T566 (Bending Resistance (Stiffness) of Paper).

In certain embodiments the back of the stack or the backing sheet, if present, may comprise a means or mounting the stack of absorbent sheets to a surface. For example, the stack may comprise an attachment mechanism for attaching the stack to a vertical surface such as a wall. The stack attachment mechanism may be provided as part of an assembly kit for users to temporarily or permanently attach the attachment mechanism to the book cover. Alternatively, the attachment mechanism may be embedded in or permanently affixed to the stack by the manufacturer during the manufacturing of the stack. The attachment mechanism may be attached by any known attachment means, including without limitation, self-adhesive hook and loop fasteners (e.g., Velcro), magnets, pressure sensitive adhesive, hooks, tabs, string, or the like. Alternatively, the stack may include a backing sheet including magnetic material where no additional attachment mechanism may be necessary to attach the stack to a metal surface.

In other embodiments a holder may be provided which may be made of metal, plastic or other suitable material and shaped to receive the bound edge of the stack to retain and hold the stack. The shape of the holder may be in the form of a flattened slotted tube or channel member open at least on one end to receive the bound edge of the stack. The holder may provide a means for fastening the holder to a vertical surface. When mounting the stack, the holder is fastened on a wall, or the like, and the stack is engaged therewith by inserting one end of the bound edge into the channel.

To manufacture a bound stack of absorbent sheets according to the present invention, a plurality of sheets are cut to size and stacked in facing arrangement. In a particularly preferred embodiment the sheets are stacked in alignment with one another, that is that the machine directions of the sheets are aligned with one another and more preferably are aligned such that subsequent stitching is substantially perpendicular to the machine direction of the sheet. The bonding of the sheets to one another to form the binding element and join the sheets into a stack may be carried out using thermal fusion bonding. The bonding may be done in a continuous fashion throughout one dimension of the stack of sheets or may be discrete so as to create discrete bonded areas. Regardless of whether the binding element is continuous or discontinuous or comprises continuous or discontinuous compressed areas, it may be advantageous to maintain the bound area as low as possible to provide adequate stack stability and sheet joining, but permit a user to easily remove single sheets from the stack. For example, it may be preferable that the area of the binding element be less than about 20 percent of the total surface area of the stack, and more preferably less than about 15 percent and still more preferably less than about 10 percent of the total surface area of the stack. In certain embodiments the bound area of the stack may range from about 20 to about 100 cm², such as from about 30 to about 80 cm². In other embodiments the sheets may have a width from about 18 to about 22 cm and the bound area may range from about 20 to about 60 cm², such as from about 30 to about 40 cm².

The pressure applied to the nip and form the binding element is generally greater than about 5,000 pounds per square inch (about 345 bars), such as from about 5,000 to about 40,000 psi (about 345 to about 2750 bars) and more preferably from about 10,000 to about 30,000 psi, such as from about 15,000 to about 25,000 psi. The pressure generally refers to the pressure applied to the nip. The actual pressure per unit area in the nip will depend upon the force applied to the nip elements, such as the rolls forming a nip, the surface area of the nip, which may be affected by the diameter of the rolls forming a nip, and the properties, particularly hardness, of the materials forming the nip elements. In addition to pressure, heat may be used to facilitate formation of the binding area. The nip used to apply pressure and form the binding element may be heated or the stack of sheets themselves may be heated. For example, the nip can be heated to a temperature greater than about 200° C., such as from about 200 to about 300° C. and more preferably from about 220 to about 260° C. In other embodiments the sheets can be preheated prior to entering the nip. In such an embodiment, the sheet can be guided around a heated roll to heat the sheets to a temperature of between about 180 to about 250° C.

In certain embodiments the process of forming the stack may comprise passing the stack of sheets between a rotating patterned element having a single pattern roll or a series of patterns disposed thereon and an anvil. The anvil element may be a smooth anvil roll. Desirably, the pattern roll(s) and the anvil roll are hardened-metal rolls. The rotating elements have a substantially continuous uniform area of localized surface contact which produces a compressed area on the stack of absorbent sheets that may range from about 5 to about 20 percent of the total surface area stack and more preferably from about 8 to about 12 percent.

According to one aspect of the process a pressure load is applied against the rotating elements so that the load on the plies of fibrous cellulosic material between the elements. The amount of pressure applied to the rotating elements may be greater than about 5,000 psi, and more preferably greater than about 10,000 psi, such as from about 5,000 to about 40,000 psi and more preferably from about 10,000 to about 25,000 psi. Further, the one or more of the rotating elements may be heated such that they surface temperature is greater than about 200° C. and more preferably greater than about 220° C., such as from about 200 to about 300° C.

Under the pressure, and optionally heat, developed by the binding apparatus the fibers in the compressed areas may become entangled, hydrogen bonded or glassined to join facing sheets to one another. Any desired pattern may be used to enhance the appearance of the binding element and to achieve the desired sheet adhesion.

In certain embodiments a portion of the sheets or the stack may be wetted, such as by the addition of water, to facilitate the formation of the binding element. Accordingly, in another aspect of the process, the sheets may be wetted so as to have a moisture content of at least about 2.0 percent, by weight. For example, at least a portion of the sheet within the stack may have a moisture content of from about 2.0 to about 10 percent, by weight.

Optionally, a wetting agent, such as a surfactant, may be added to the water to improve wetting of the sheet and formation of the binding element. The surfactant may be an ionic surfactant, i.e. a cationic or anionic surfactant, or a mixture of both, or a nonionic surfactant or a mixture thereof with either a cationic or anionic surfactant. In a particularly preferred embodiment the surfactant is an alkyl ethoxylates comprising from about 9 to about 12 carbon atoms in the hydrophobic tail, and from about 4 to about 9 ethylene oxide units in the hydrophilic head group.

While the inventive stacks of absorbent sheets have been described in detail with respect to the specific embodiments thereof, it will be appreciated that those skilled in the art, upon attaining an understanding of the foregoing, may readily conceive of alterations to, variations of, and equivalents to these embodiments. Accordingly, the scope of the present invention should be assessed as that of the appended claims and any equivalents thereto and the foregoing embodiments:

In a first embodiment the present invention provides a stack of absorbent sheets comprising a plurality of absorbent sheets having a machine direction and a cross-machine direction stacked in facing arrangement without an adhesive disposed there between to form a stack of absorbent sheets, the stack having a top edge and a bottom edge; the stack having a compressed region and an uncompressed region, wherein the compressed region forms a binding element having a thickness (T₁) that is less than the thickness of the uncompressed region (T₃).

In a second embodiment the present invention provides the stack of absorbent sheets of the first embodiment wherein the absorbent sheets have a basis weight greater than about 10 grams per square meter (gsm), a geometric mean tensile strength (GMT) from about 500 to about 3,500 g/3″ and a vertical absorbent capacity greater than about 4.0 g/g.

In a third embodiment the present invention provides the stack of absorbent sheets of the first or the second embodiments wherein the plurality of absorbent sheets comprises half-folded or quarter-folded absorbent sheets.

In a fourth embodiment the present invention provides the stack of absorbent sheets of any one of the first through the third embodiments wherein the binding element is continuous.

In a fifth embodiment the present invention provides the stack of absorbent sheets of any one of the first through the fourth embodiments wherein the binding element is discontinuous.

In a sixth embodiment the present invention provides the stack of absorbent sheets of the fifth embodiment wherein the binding element comprises first and second compressed areas having first (T₁) and second thicknesses (T₂) that are less than the thickness (T₃) of the uncompressed portion of the stack.

In a seventh embodiment the present invention provides the stack of absorbent sheets of any one of the first through the sixth embodiments further comprising a backing sheet or strip, wherein the backing sheet or strip has a Taber Stiffness greater than the plurality of absorbent sheets.

In an eighth embodiment the present invention provides the stack of absorbent sheets of any one of the first through the seventh embodiments wherein the stack is substantially free from adhesive.

In a ninth embodiment the present invention provides the stack of absorbent sheets of any one of the first through the eighth embodiments wherein the area of the binding element is from about 5.0 to about 10 percent of the surface area of the stack.

In a tenth embodiment the present invention provides the stack of absorbent sheets of any one of the first through the ninth embodiments wherein the binding element has a length (l₁) that is from about 5.0 to about 15 percent of length (L) of the stack.

In an eleventh embodiment the present invention provides the stack of absorbent sheets of any one of the first through the tenth embodiments wherein the plurality of absorbent sheets are free from perforations and lines of weakness.

In a twelfth embodiment the present invention provides the stack of absorbent sheets of any one of the first through the eleventh embodiments wherein the plurality of absorbent sheets have a rectilinear shape.

In a thirteenth embodiment the present invention provides the stack of absorbent sheets of any one of the first through the eleventh embodiments wherein the plurality of absorbent sheets have at least one edge that is non-linear.

In a fourteenth embodiment the present invention provides the stack of absorbent sheets of any one of the first through the thirteenth embodiments wherein the binding element has a length (l₁) and a width (w) that is less than the length (L) and width (W) of the stack.

In a fifteenth embodiment the present invention provides the stack of absorbent sheets of any one of the first through the fourteenth embodiments wherein the binding element forms a portion of the top edge and at least a first side edge of the stack.

In a sixteenth embodiment the present invention provides a method of manufacturing a stack of absorbent sheets bound without the use of adhesives or mechanical fasteners comprising the steps of providing a plurality of absorbent sheets; stacking the plurality of absorbent sheets in facing arrangement with one another such that the facings of adjacent sheets in the stack are in direct contact with one another; passing a portion of the stack through a nip loaded with a pressure of at least about 10,000 psi to compress a portion of the stack and form a binding element and an adjacent uncompressed region, wherein the binding element has a thickness (T₁) that is less than the thickness (T₃) of the uncompressed region.

In a seventeenth embodiment the present invention provides the method of the sixteenth embodiment wherein the plurality of absorbent sheets comprise a wet-laid tissue web that has been printed with a binder and then creped. In certain embodiments the foregoing printed creped tissue web has the binder applied substantially uniformly, in terms of amount per unit of surface area, in both the machine and cross-machine directions of the sheet.

In an eighteenth embodiment the present invention provides the method of the sixteenth or seventeenth embodiments wherein the plurality of absorbent sheets have a basis weight greater than about 10 grams per square meter (gsm), a geometric mean tensile strength (GMT) from about 500 to about 3,500 g/3″ and a vertical absorbent capacity greater than about 4.0 g/g.

In an nineteenth embodiment the present invention provides the method of the sixteenth through eighteenth embodiments wherein the nip is loaded with a pressure ranging from about 10,000 to about 40,000 psi.

In a twentieth embodiment the present invention provides the method of the sixteenth through nineteenth embodiments wherein the nip has a temperature from about 200 to about 300° C.

In a twenty-first embodiment the present invention provides the method of the sixteenth through twentieth embodiments wherein T₁ is from about 5.0 to about 15 percent of T₃.

In a twenty-second embodiment the present invention provides the method of the sixteenth through twenty-first embodiments wherein the stack has a width (W) and the binding element is continuous and has a width substantially equal to the width (W) of the stack and forms at least a portion of the top edge of the stack.

In a twenty-third embodiment the present invention provides the method of the sixteenth through twenty-second embodiments further comprising the step of wetting at least a portion of the plurality of absorbent sheets prior to passing a portion of the stack through a nip. In certain preferred embodiments the step of wetting may comprise spraying an aqueous solution comprising water and a surfactant on a portion of the sheet surface.

In a twenty-fourth embodiment the present invention provides the method of the sixteenth through the twenty-third embodiments further comprising the steps of cutting the sheets to size prior to stacking and optionally folding the sheets.

In a twenty-fifth embodiment the present invention provides the method of the sixteenth through the twenty-fourth embodiment wherein the sheets have a width of at least about 15 cm, such as from about 15 to about 25 cm, the binding element has an area from about 20 to about 60 cm², such as from about 30 to about 40 cm² and the first thickness (T₁) is from about 10 to about 15 percent of the second thickness (T₂).

What is claimed is:

1. A stack of absorbent sheets having a top surface and an opposed bottom surface, the stack comprising: a plurality of absorbent sheets having a machine direction and a cross-machine direction stacked in facing arrangement without an adhesive disposed there between to form a stack of absorbent sheets, the stack having a top edge and a bottom edge; the stack having a compressed region and an uncompressed region, wherein the compressed region forms a binding element having a minimum thickness (T₁) that is less than the thickness of the uncompressed region (T₃).

2. The stack of absorbent sheets of claim 1 wherein the stack has a width (W) and the binding element is continuous and has a width substantially equal to the width (W) of the stack.

3. The stack of absorbent sheets of claim 1 wherein the binding comprises first and second compressed areas having a first thickness (T₁) and a second thickness (T₂) that are less than the thickness (T₃) of the uncompressed portion of the stack.

4. The stack of absorbent sheets of claim 3 wherein the stack has a width (W) and the binding element is continuous and has a width substantially equal to the width (W) of the stack.

5. The stack of absorbent sheets of claim 3 wherein the first and second compressed areas are discrete and have a rectilinear shape.

6. The stack of absorbent sheets of claim 3 wherein the first compressed areas are discrete and have a non-linear shape.

7. The stack of absorbent sheets of claim 1 wherein the stack comprises a plurality of discrete compressed regions and the binding element is discontinuous.

8. The stack of absorbent sheets of claim 1 wherein the absorbent sheets have a basis weight greater than about 10 grams per square meter (gsm), a geometric mean tensile strength (GMT) from about 500 to about 3,500 g/3″ and a vertical absorbent capacity greater than about 4.0 g/g.

9. The stack of absorbent sheets of claim 1 wherein the plurality of absorbent sheets comprises half-folded or quarter-folded absorbent sheets.

10. The stack of absorbent sheets of claim 1 wherein the plurality of absorbent sheets are free from perforations and lines of weakness.

11. A stack of absorbent sheets having a top surface and an opposed bottom surface, the stack comprising: a plurality of absorbent sheets having a machine direction and a cross-machine direction stacked in facing arrangement to form a stack of absorbent sheets, the stack having a top edge and a bottom edge; the stack having a compressed region and an uncompressed region, wherein the compressed region forms a binding element having a minimum thickness (T₁) that is less than the thickness of the uncompressed region (T₃) and wherein the binding element is substantially free from adhesive and forms at least a portion of the top edge of the stack.

12. The stack of absorbent sheets of claim 11 wherein the stack has a width (W) and the binding element is continuous and has a width substantially equal to the width (W) of the stack.

13. The stack of absorbent sheets of claim 11 wherein the binding element and the stack have a rectilinear shape.

14. The stack of absorbent sheets of claim 11 wherein the absorbent sheets have a basis weight greater than about 10 grams per square meter (gsm), a geometric mean tensile strength (GMT) from about 500 to about 3,500 g/3″ and a vertical absorbent capacity greater than about 4.0 g/g.

15. The stack of absorbent sheets of claim 11 wherein the first thickness (T₁) is from about 10 to about 15 percent of the thickness of the uncompressed region (T₃).

16. A method of manufacturing a stack of absorbent sheets bound without the use of adhesives or mechanical fasteners comprising the steps of:
a. providing a plurality of absorbent sheets;
b. stacking the plurality of absorbent sheets in facing arrangement with one another such that the facings of adjacent sheets in the stack are in direct contact with one another; and
c. passing a portion of the stack through a nip having a loading force of at least about 10,000 pounds per square inch (psi) to compress a portion of the stack and form a binding element and an adjacent uncompressed region, wherein the binding element has a thickness (T₁) that is less than the thickness of the uncompressed region (T₃).

17. The method of claim 16 wherein the nip loading force ranges from about 10,000 to about 40,000 psi.

18. The method of claim 16 wherein the nip has a temperature from about 200 to about 300° C.

19. The method of claim 16 wherein T₁ is from about 5.0 to about 15 percent of T₃.

20. The method of claim 16 wherein the stack has a width (W) and the binding element is continuous and has a width substantially equal to the width (W) of the stack and forms at least a portion of the top edge of the stack.

21. The method of claim 16 further comprising the step of wetting at least a portion of the plurality of absorbent sheets prior to passing a portion of the stack through a nip.

22. The method of claim 21 wherein the step of wetting comprises spraying an aqueous solution comprising water and a surfactant.
